(19) United States
(12) Patent Application Publication
(10) Pub. No.: US 2006/0032243 A1
(43) Pub. Date: Feb. 16, 2006

(54) Injection molding device with cooling system having carbon nanotube superfluid

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/977,977

(22) Filed: Oct. 29, 2004

(30) Foreign Application Priority Data
Nov. 20, 2003 (CN) 200310112314.2

(51) Int. Cl. C09K 5/04

(52) U.S. Cl. 62/114

(57) ABSTRACT

An injection molding device includes an injection unit (10), a lock unit, and a control unit. The injection unit includes a mold (11, 11′) and a cooling system. The cooling system includes one or more pipeways (18, 18′) in the mold, and a coolant received in the pipeways. The coolant is a superfluid with carbon nanotubes suspended therein. A coefficient of viscosity of the superfluid is virtually zero, therefore friction between the superfluid and the nanotubes is extremely small. This enables the nanotubes in the superfluid in the pipeways to undergo more turbulent flow, so that the nanotubes can conduct more heat from the mold. In addition, the nanotubes themselves have high thermal conductivity. Accordingly, the thermal conductivity of the cooling system is enhanced. Thus, the molten material injected into the mold can be cooled and solidified fast. This provides the injection molding device with a high molding efficiency.

### BACKGROUND OF THE INVENTION

1. Field of the Invention

The invention relates generally to molding devices, and more particularly to an injection molding device having a high efficiency cooling system.

2. Description of the Prior Art

In industry, molding devices are in widespread use for manufacturing products such as plastics and glasses. Molding methods employed by molding devices comprise the injection molding method, the press molding method, the blow molding method, and the foam molding method. Among these molding methods, the molding cycle of the injection molding method is relatively short, and the range of applications of the injection molding method is relatively broad. Generally, the molding cycle of the injection molding method is in the range from several seconds to several minutes, and the weight of the product manufactured by the injection molding method is in the range from several grams to several tens of kilograms. Thus, the injection molding method has a high molding efficiency and is adopted widely throughout industry.

An injection molding device employing the injection molding method typically comprises an injection unit, a lock unit, and a control unit. The injection unit comprises a mold and a cooling system. The cooling system comprises one or more pipeways within the mold, and a coolant received in the pipeways. Generally, the injection molding method comprises the steps of closing the mold, injecting molten material into the mold, holding the molten material under pressure, cooling the molten material, and opening the mold. These processes are repeated cyclically in order to make the desired number of products. The holding under pressure step and the cooling step determine a precise size of the product, and these two steps are considered relatively more important in the manufacturing process. Accordingly, the cooling system of the injection molding device must have a high cooling efficiency.

In a conventional injection molding device, the coolant of the cooling system is water. U.S. Pat. No. 5,368,089 discloses a cooling device for cooling molten material, in which water is adopted as the coolant. Water has a large specific heat and is inexpensive. However, the thermal conductivity of water is low. The cooling device has a low cooling efficiency, and the corresponding injection molding device has a relatively poor molding efficiency.

A new injection molding device which overcomes the above-mentioned problems is desired.

### BRIEF SUMMARY OF THE INVENTION

Accordingly, an object of the present invention is to provide an injection molding device having a highly efficient cooling system.

To achieve the above-mentioned object, the present invention provides an injection molding device comprising an injection unit, a lock unit and a control unit. The injection unit comprises a mold and a cooling system. The cooling system comprises one or more pipeways in the mold, and a coolant received in the pipeways. The coolant is a superfluid with carbon nanotubes suspended therein.

Compared with a conventional injection molding device, the injection molding device of the present invention has the following advantages. Firstly, because a coefficient of viscosity of the superfluid is virtually zero, friction between the superfluid and the carbon nanotubes is extremely small. This enables the carbon nanotubes in the superfluid in the pipeways to undergo more turbulent flow, so that the carbon nanotubes can conduct more heat from the mold. Secondly, because the carbon nanotubes have high thermal conductivity, the thermal conductivity of the cooling system is enhanced. Thus, the molten material injected into the mold can be cooled and solidified fast. This provides the injection molding device with a high molding efficiency.

Other objects, advantages and novel features of the invention will become more apparent from the following detailed description when taken in conjunction with the accompanying drawings, in which:

### BRIEF DESCRIPTION OF THE DRAWINGS

FIG. 1 is a schematic, cross-sectional view of an injection unit of an injection molding device of the present invention;

FIG. 2 is a cross-sectional view of part of a mold of the injection unit of FIG. 1, the mold having a pipeway therein;

FIG. 3 is a schematic diagram showing a path of circulatory movement of coolant in the pipeway of the mold of FIG. 2;

FIG. 4 is a cross-sectional view of part of a mold in accordance with an alternative embodiment of the present invention, the mold having a plurality of pipeways therein; and

FIG. 5 is a schematic diagram showing paths of circulatory movement of coolant in the pipeways of the mold of FIG. 4.

### DESCRIPTION OF THE PREFERRED EMBODIMENTS

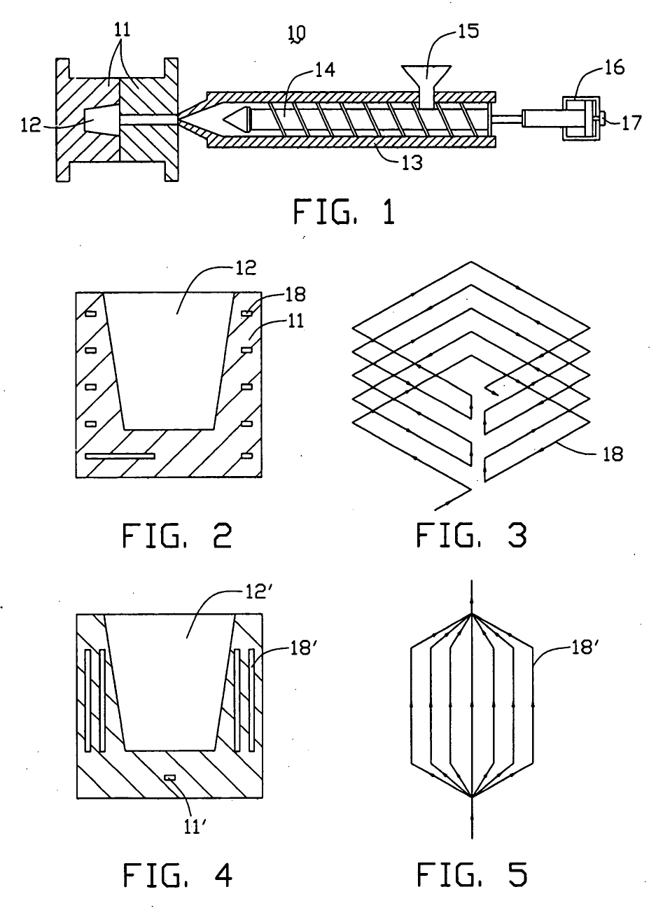

Referring to FIG. 1, an injection molding device of the present invention comprises an injection unit 10, a lock unit (not shown) and a control unit (not shown). The injection unit 10 comprises a mold 11, a central cavity 12 defined in the mold 11, a cooling system (not labeled) within the mold 11, a press cylinder 13 connected with the mold 11, a screw 14 positioned in the press cylinder 13, a hopper 15 connected with the press cylinder 13, a piston assembly 16 fixed to the screw 14, and a motor 17 connected with the screw 14. Referring to FIG. 2, the cooling system comprises a pipeway 18 in the mold 11, and a liquid coolant (not shown) received in the pipeway 18. FIG. 3 is a schematic diagram showing a path of circulatory movement of the coolant in the pipeway 18.

Referring to FIG. 4, in an alternative embodiment, the mold 11 is replaced by a mold 11′. The mold 11′ defines a central cavity 12′, and has a plurality of pipeways 18′ therein. The pipeways 18′ are interconnected in parallel as shown in FIG. 5.

The coolant comprises a superfluid and a plurality of carbon nanotubes suspended therein. The superfluid is selected from the group consisting of superfluid helium (He), superfluid nitrogen (N₂), superfluid C₂H₂F₂Cl₂, superfluid C₆F₁₄, and superfluid C₆H₂F₁₂.

Use of the injection molding device is as follows. Firstly, the mold 11 is closed by the lock unit. Secondly, feedstock is fed in the press cylinder 13 via the hopper 15. Thirdly, the press cylinder 13 is heated, and the motor 17 is activated to drive the screw 14 to rotate in the press cylinder 13. The screw 14 mixes the feedstock until it is molten. Fourthly, the piston assembly 16 is activated, and the molten material is injected into the cavity 12. Fifthly, the molten material is held in the injection molding device, and the cooling system is activated. The molten material is thus cooled and solidified in the mold 11.

Compared with a conventional injection molding device, the injection molding device of the present invention has the following advantages. Firstly, because a coefficient of viscosity of the superfluid is virtually zero, friction between the superfluid and the carbon nanotubes is extremely small. This enables the carbon nanotubes in the superfluid in the pipeway 18 to undergo more turbulent flow, so that the carbon nanotubes can conduct more heat from the mold 11. Secondly, because the carbon nanotubes have high thermal conductivity, the thermal conductivity of the cooling system is enhanced. Thus the molten material injected into the mold can be cooled and solidified fast. This provides the injection molding device with a high molding efficiency.

It is to be understood that the above-described embodiments are intended to illustrate rather than limit the invention. Variations may be made to the embodiments without departing from the spirit of the invention. Accordingly, it is appropriate that the appended claims be construed broadly and in a manner consistent with the scope of the invention.

What is claimed is:

1. A cooling system for cooling an object, the cooling system comprising:
at least one pipeway; and
a coolant received in said pipeway;
wherein the coolant comprises a superfluid, and a plurality of carbon nanotubes suspended in the superfluid.

2. The cooling system as claimed in claim 1, wherein the superfluid is selected from the group consisting of superfluid helium (He), superfluid nitrogen (N₂), superfluid C₂H₂F₂Cl₂, superfluid C₆F₁₄, and superfluid C₆H₂F₁₂.

3. The cooling system as claimed in claim 1, wherein the cooling system comprises a plurality of pipeways, and the pipeways are connected in parallel.

4. An injection molding device comprising:
a control unit;
a lock unit; and
an injection unit comprising a mold and a cooling system, the cooling system comprising at least one pipeway in the mold and a coolant received in said pipeway;
wherein the coolant comprises a superfluid, and a plurality of carbon nanotube suspended in the superfluid.

5. The injection molding device as claimed in claim 4, wherein the superfluid is selected from the group consisting of superfluid helium (He), superfluid nitrogen (N₂), superfluid C₂H₂F₂Cl₂, superfluid C₆F₁₄, and superfluid C₆H₂F₁₂.

6. The injection molding device as claimed in claim 4, wherein the cooling system comprises a plurality of pipeways, and the pipeways are connected in parallel.

7. A method for cooling an object, comprising:
providing at least one pipeway extending next to said object; and
supplying a superfluid-containing coolant continuously passing through said at least one pipeway to perform heat-interchanging with said object.

8. The method as claimed in claim 7, wherein a plurality of carbon nanotube is suspended in said superfluid.

9. The method as claimed in claim 7, wherein said superfluid is selected from the group consisting of superfluid helium (He), superfluid nitrogen (N₂), superfluid C₂H₂F₂Cl₂, superfluid C₆F₁₄, and superfluid C₆H₂F₁₂.
